(19) United States
(12) Patent Application Publication
(10) Pub. No.: US 2009/0007049 A1
(43) Pub. Date: Jan. 1, 2009

(54) AUTOMATIC TRACE DESIGN METHOD

(75) Inventor: Tamotsu Kitamura, Nagano (JP)

Correspondence Address: PAUL AND PAUL, 2000 MARKET STREET, SUITE 2900, PHILADELPHIA, PA, 19103, US

(73) Assignee: SHINKO ELECTRIC INDUSTRIES CO., LTD, Nagano (JP)

(21) Appl. No.: 12/127,890

(22) Filed: May 28, 2008

(30) Foreign Application Priority Data
Jun. 29, 2007 (JP) 2007-172980

(51) Int. Cl. G06F 17/50

(52) U.S. Cl. 716/15

(57) ABSTRACT

An automatic trace design method comprises: a tentative passing point setting step of setting, on a virtual plane corresponding to a substrate surface, tentative passing points through which a trace subject to route determination should pass; a triangle setting step of setting triangles, each of which is formed by one of the tentative passing points and two points on either side of such tentative passing point among a starting point, an end point and the other of the tentative passing points; and a determination step of determining points in the neighborhood of respective obstacles that are located inside the respective triangles mentioned above and most adjacent to the respective tentative passing points as final passing points through which the trace subject to route determination should pass, wherein the route that passes through the final passing points is determined as the optimal route of the trace subject to route determination.

### BACKGROUND OF THE INVENTION

1. Field of the Invention

The present invention relates to an automatic trace design method for determining positions of a trace route on a substrate surface by using a virtual plane corresponding to the substrate surface by an arithmetic processing unit.

2. Description of the Related Art

Typical examples of automatic wiring methods for LSI and PCB are, e.g. labyrinth search methods as set forth in Japanese Unexamined Patent Publication No. 11-161694, Japanese Unexamined Patent Publication No. 2001-350813, Japanese Unexamined Patent Publication No. 2001-044288, and Japanese Unexamined Patent Publication No. 10-209288, in which trace routes on a substrate are set to maintain clearance from obstacles and not intersect obstacles by bypassing such obstacles in the directions of 90 degrees or, in some cases, 45 degrees. Such a setting technique can be implemented, in particular, in LSI, PCB etc., which have peculiar pattern characteristics in that positions and shapes of the obstacles in the LSI, PCB and the like have a certain regularity.

On substrates of semiconductors such as PBGA, EBGA and the like, there are a large number of elements, such as planes, gates, marks, internal components or other traces in the packages, etc., which may obstruct the traces and shapes and disposed positions or angles of such obstacles may vary significantly. Further, vias, balls, bonding pads (B/P), flip chip pads (F/C) etc., which are to be starting or end points of the traces, may be positioned, in various positions. Therefore, in a trace design of semiconductor packages, when the obstacles on the substrate are bypassed, the trace routes have to bypass the obstacles in the direction of arbitrary angles, which are not limited to 90 or 45 degrees. Thus, the labyrinth search method that has been conventionally used for automatic wiring in LSI, PCB and the like cannot be applied to the semiconductor packages.

In view of such circumstances, in the trace design of the semiconductor packages, a designer typically designs trace routes of semiconductor packages on a virtual plane by trial and error depending on the designer's skill, experience and intuition, for example, by using a CAD system.

In contrast to this, as described in Japanese Unexamined Patent Publication No. 2007-079738, there is an automatic trace determination method for automatically determining a trace route on a substrate that does not intersect other traces on the substrate. In this method, two points that are to be a starting point and an end point of a trace are connected by an inspection line, and when this inspection line intersects with other traces, a straight line section connecting between the above-mentioned starting point and one terminal point of one trace that is closest to the starting point is determined as a segment that constitutes a candidate for an optimal route. Then, the terminal point used for determining the above-mentioned candidate is reset as a new starting point. Further, based on an inspection line newly connecting between the new starting point and the end point, the above-mentioned, processes are performed repeatedly to generate candidate routes constituted by segments. Eventually, an optimal route is determined from the candidate routes thus generated.

Further, as described in Japanese Unexamined Patent Publication No. 2006-331017, there is an automatic trace determination method for automatically determining a trace route on a substrate that does not intersect obstacles on the substrate. In this method, when there is an obstacle on a straight line connecting between two points that are to be a starting point and an end point of a trace, first, tentative routes, each of which includes at least a straight route from the starting point that is tangent to the obstacle and a straight route from the end point that is tangent to the obstacle, are set. Specifically, when there are a plurality of obstacles on the straight line between the two points that are to be the starting point and the end point of the trace, each of the tentative routes further includes a straight route that is tangent only to two of the obstacles and does not intersect with any obstacle other than such two obstacles. The straight routes that are tangent to two of the obstacles are set with respect to each pair of the two of the obstacles. The tentative route that has the shortest distance between the starting point and the end point of the trace is determined to be the optimal trace route.

Still further, as described in Japanese Unexamined Patent Publication No. 2006-268462, there is an automatic trace determination apparatus that can determine trace positions automatically by computation when optimal trace positions from pads to corresponding vias on a substrate are designed, even if a portion of the traces are oriented in the direction substantially opposite to the dominant direction. This apparatus comprises: a first intersection resolving means that performs a first intersection resolving process for all intersections formed between tentative traces connecting between the pads and the corresponding vias by straight lines sequentially from the intersection nearest the pads, wherein the first intersection resolving process allows one of the tentative traces that forms an intersection with the other tentative traces to bypass the via, with which the other tentative traces are connected, so that the intersection formed between the two tentative traces can be resolved and defines this bypass trace as an interim trace; and a second intersection resolving means that, alter the first intersection resolving process is completed by the first intersection resolving means, performs a second intersection, resolving process for all intersections formed between the interim traces themselves and intersections formed between the interim and tentative traces sequentially from the intersection nearest to the pads, wherein the second intersection resolving process allows one of the interim or tentative traces that forms an intersection with the other interim or tentative traces to bypass the via, with which the other interim or tentative traces are connected, so that the intersection formed between the interim traces or the intersections formed between the interim and tentative traces can be resolved and defines this bypass trace as an optimal trace.

The invention described in above Japanese Unexamined Patent Publication No. 2007-079738, Japanese Unexamined Patent Publication No. 2006-331017 and Japanese Unexamined Patent Publication. No. 2006-268462 is an automatic trace design method or apparatus for determining positions of an optimal trace route on a substrate surface by using a virtual plane corresponding to the substrate surface by an arithmetic processing unit can be applied to a case in which disposed positions of two terminals that are to be a starting point and an end point of a trace whose route is to be determined (hereinafter referred to as “a trace subject to route determination”) on a virtual plane are already determined in design data.

However, even though a trace is designed automatically by using an arithmetic processing unit, a designer can override the automatic process and adopt an alternate design.

Further, a position of a terminal at an end point of a trace subject to route determination may be uncertain in design data, such as when a position of a plated lead is determined or a trace subject to route determination is connected in a T-junction manner.

The “ambiguity” in trace design as described above cannot be accommodated by the examples of the conventional art described above for automatically designing the trace by using the arithmetic processing unit, which lacks flexibility. Further, if a designer designs the trace on the virtual plane by using a CAD system, the “ambiguity” described above can be accommodated, but It takes a lot of time.

In view of the above problems, it is an object of the present invention to provide an automatic trace design method that can determine positions of a trace route on a substrate surface by using a virtual plane corresponding to the substrate surface automatically in a short time by an arithmetic processing unit.

### SUMMARY OF THE INVENTION

In order to achieve the above object, according to a first aspect of the present invention, there is provided an automatic trace design method for determining, with respect to a trace subject to route determination in which only positions of a starting point and an end point are determined, positions of an optimal route between the starting point and the end point by an arithmetic processing unit, the method comprising: a tentative passing point setting step of setting, on a virtual plane, approximate positions through which the trace subject to route determination should at least pass as tentative passing points; a triangle setting step of setting triangles, each of which is formed by one of the tentative passing points and two points on either side of such tentative passing point among the starting point, the end point and the other of the tentative passing points; and a determination step of determining points in the neighborhood of respective obstacles that may disturb trace design and that are located inside the respective triangles mentioned above and most adjacent to the respective tentative passing points as final passing points through which the trace subject to route determination should pass, wherein the route that passes through the final passing points is determined as the positions of the optimal route of the trace subject to route determination.

According to a second aspect of the present invention, there is provided an automatic trace design method for determining an optimal route of a trace on a substrate surface as a route that is constituted by connecting a plurality of segments on a virtual plane corresponding to the substrate surface by an arithmetic processing unit, wherein the optimal route is determined with respect to a trace subject to route determination that is determined to terminate at any position on a predetermined line on the virtual plane, the method comprising: a tentative end point setting step of setting, on the virtual plane, a tentative end point on the predetermined line where the trace subject to route determination should terminate so that a segment including the tentative end point or a terminating segment is orthogonal to the predetermined line; a checking step of checking clearance from obstacles that are located in the neighborhood of the terminating segment and that may disturb trace design; and an end point determination step of determining the position of the tentative end point as an end point of the trace subject to route determination if the clearance is secured as a result of the check in the checking step.

Further, according to a third aspect of the present invention, there is provided an automatic trace design method for determining route positions of a plated lead on a substrate surface by using a virtual plane corresponding to the substrate surface by an arithmetic processing unit, the method comprising: a tentative setting step of setting, on the virtual plane corresponding to the substrate surface, a tentative route from a predetermined starting point of a plated lead to an edge of the substrate; a counting step of counting the number of intersections of the tentative route and an other existing trace; a replacement step of replacing the tentative route by another tentative route that passes through terminals at both ends of the other existing trace if the number of intersections is an odd number, wherein the counting process in the counting step is performed again for the new tentative route; a further tentative setting step of setting further tentative routes that connect between the starting point, the respective one of the bend points of the other trace, and an intersection point of the tentative route and an edge of the substrate if the number of intersections is an even number; a setting step of setting one of the further tentative routes that has a shorter distance between the starting point and the intersection point as a route to be corrected; and a correction step for correcting the route to be corrected to an optimal route that can secure a predetermined clearance from obstacles that may disturb trace design, wherein a route is set so as to run from a point on the optimal route in the neighborhood of the obstacle nearest to the edge of the substrate among the obstacles referenced in the route correction and so as to be orthogonal to the edge of the substrate.

In this connection, the steps of the automatic trace design method according to the first to third aspects of the present invention can be implemented in the form of a software program that can be operated by an arithmetic processing unit such as a computer. An apparatus for performing the above-mentioned processes and a program for allowing the computer to perform the above-mentioned processes can be easily implemented by those skilled in the art by the following detailed description. Further, it would also be obvious to those skilled in the art that the program for executing the above-mentioned processes may be stored in storage media.

### BRIEF DESCRIPTION OF THE DRAWINGS

The present invention will be more clearly understood from the description as set below with reference to the accompanying drawings, wherein:

FIG. 1 is a flow chart showing an operational flow of an automatic trace design method according to a first embodiment of the present invention;

FIG. 2 is a diagram (part 1) showing a specific example of trace route determination based on the automatic trace design method according to the first embodiment of the present invention;

FIG. 3 is a diagram (part 2) showing a specific example of trace route determination based on the automatic trace design method according to the first embodiment of the present invention;

FIG. 4 is a diagram (part 3) showing a specific example of trace route determination based on the automatic trace design method according to the first embodiment of the present invention;

FIG. 5 is a diagram (part 4) showing a specific example of trace route determination based on the automatic trace design method according to the first embodiment of the present invention;

FIG. 6 is a diagram (part 1) showing a specific example of determination of a trace route that passes through final passing points determined as shown in FIG. 5 based on the automatic trace design method according to the first embodiment of the present invention;

FIG. 7 is a diagram (part 2) showing a specific example of determination of a trace route that passes through final passing points determined as shown in FIG. 5 based on the automatic trace design method according to the first embodiment of the present invention;

FIG. 8 is a diagram (part 3) showing a specific example of determination of a trace route that passes through final passing points determined as shown in FIG. 5 based on the automatic trace design method according to the first embodiment of the present invention;

FIG. 9 is a flow chart showing an operational flow of an automatic trace design method according to a second embodiment of the present invention;

FIG. 10 is a diagram (part 1) showing a specific example of trace route determination based on the automatic trace design method according to the second embodiment of the present invention;

FIG. 11 is a diagram (part 2) showing a specific example of trace route determination based on the automatic trace design method according to the second embodiment of the present invention;

FIG. 12 is a diagram (part 3) showing a specific example of trace route determination based on the automatic trace design method according to the second embodiment of the present invention;

FIG. 13 is a diagram (part 4) showing a specific example of trace route determination based on the automatic trace design method according to the second embodiment of the present invention;

FIG. 14 is a flow chart, showing an operational flow of an automatic trace design method according to a third embodiment of the present invention;

FIG. 15 is a diagram (part 1) showing a specific example of trace route determination based on the automatic trace design method according to the third embodiment of the present invention;

FIG. 16 is a diagram (part 2) showing a specific example of trace route determination based on the automatic trace design method according to the third embodiment, of the present invention;

FIG. 17 is a diagram (part 3) showing a specific example of trace route determination based on the automatic trace design method according to the third embodiment of the present invention;

FIG. 18 is a diagram (part 4) showing a specific example of trace route determination based on the automatic trace design method according to the third embodiment of the present invention; and

FIG. 19 is a block diagram showing a configuration of a computer that operates according to a program that is stored on a storage medium.

### DESCRIPTION OF THE PREFERRED EMBODIMENTS

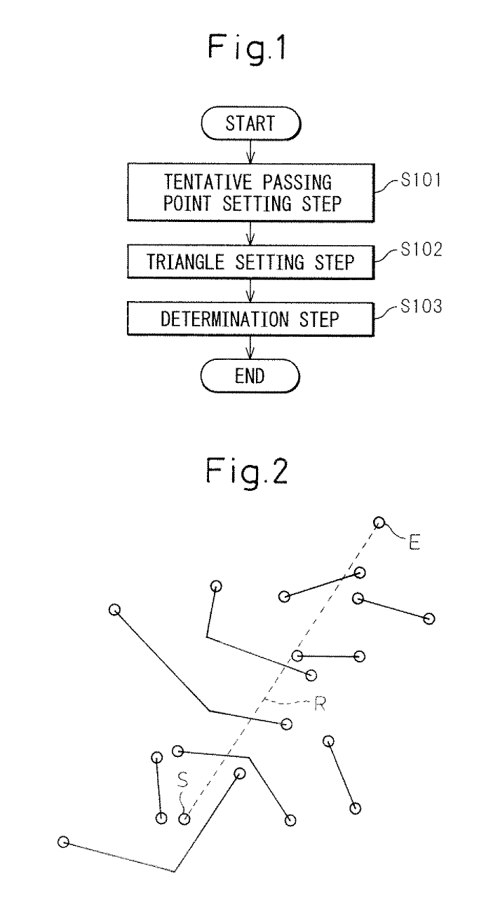

In an automatic trace design method according to the first embodiment of the present invention, on a virtual plane corresponding to a substrate surface, with respect to a trace subject to route determination in which only positions of a starting point S and an end point E are determined, positions of an optimal route between the starting point and the end point are determined by using an arithmetic processing unit such as a computer. FIG. 1 is a flow chart showing an operational flow of the automatic trace design method according to the first embodiment of the present invention. Further, FIGS. 2-5 are diagrams showing a specific example of trace route determination based on the automatic trace design method according to the first embodiment of the present invention. In FIGS. 2-5, trace terminals are Indicated by circles and traces connecting the terminals are indicated by solid lines.

As a specific example, as shown in FIG. 2, it is assumed that only positions of the starting point S and the end point E of the trace subject to route determination are determined on the virtual plane. In FIGS. 2-5, the relationship between the starting point S and the end point E is represented by a rat's nest R, which is indicated by a dotted line in the figures.

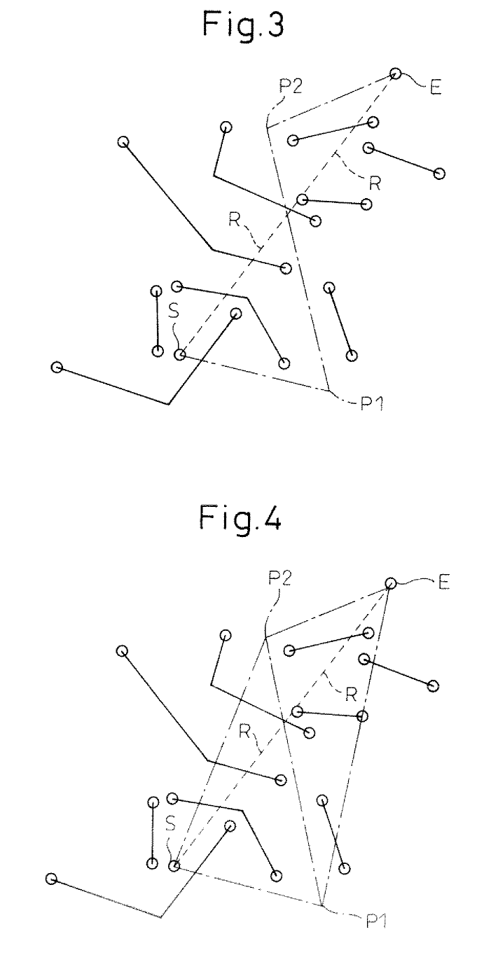

First, in a tentative passing point setting step S101, on the virtual plane corresponding to the substrate surface, the arithmetic processing unit such as the computer sets approximate positions through which a trace subject to route determination should at least pass as tentative passing points. These tentative passing points may be approximate positions at least around which the trace is desired to pass on the virtual plane. For example, as shown in FIG. 3, when a designer wishes that the trace subject to route determination passes around points P1 and P2, the designer inputs this information to the arithmetic processor.

Next, in a triangle setting step S102, triangles, each of which is formed by one of the tentative passing points and two points on either side of such tentative passing point subject to clearance check among the starting point, the end point and the other of the tentative passing points, are set. For example, as shown in FIG. 4, a triangle S-P1-P2 constituted by the tentative passing point P1 and the starting point S and the tentative passing point P2 on either side of the tentative passing point P1 is set. Further, a triangle P1-P2-E constituted by the tentative passing point P2 and the tentative passing point P1 and the end point E on either side of the tentative passing point P2 is set.

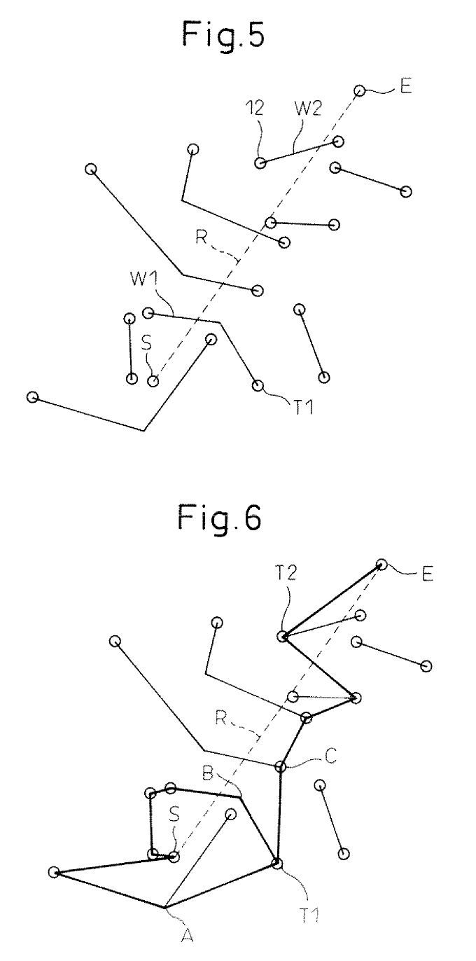

Then, in a determination step S103, points in the neighborhood of respective obstacles that may disturb trace design and that are located inside the respective triangles set in the triangle setting step S102 and most adjacent to said respective tentative passing points are determined as final passing points. For example, in the example of FIG. 5, where the obstacles are terminals of the traces other than that subject to route determination, points T1 and T2 are determined as the final passing points through which the trace subject to route determination should pass. In the example shown in FIG. 5, the final passing points T1 and T2 are indicated to be located on the respective obstacles or terminals of the respective traces W1 and W2. After the trace route subject to determination is determined by subsequent processing, in order to secure clearance between such route and the terminals of the traces W1 and W2, the positions of the final passing points T1 and T2 are corrected so as to secure clearance between the final passing points T1, T2 and the obstacles or terminals of the respective traces W1, W2.

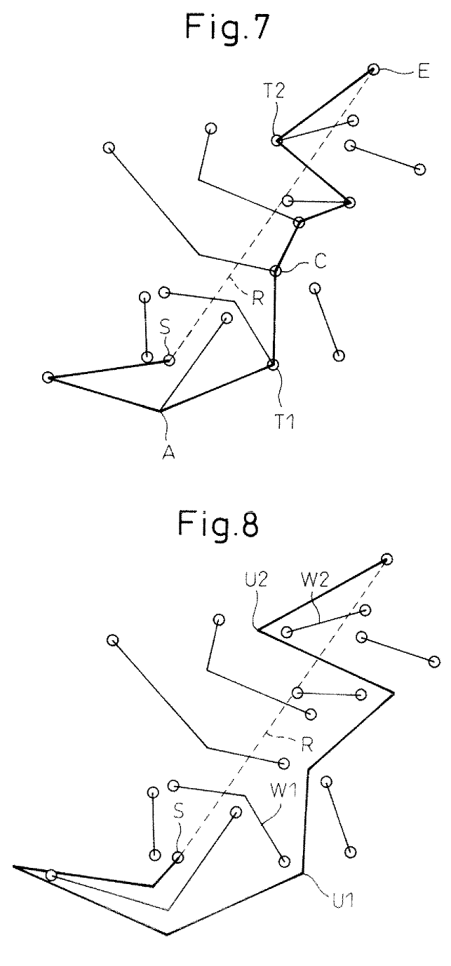

As a result of the processes described above, the positional information that has been ambiguous in the sense that “the passing points were set at the positions at least around which the trace route was desired to pass on the virtual plane” is determined as the data that can be processed by the arithmetic processing unit such as the computer. Therefore, by using this data, the route that passes the final passing points can be automatically determined as an optimal route of said trace subject to route determination by using the arithmetic processing unit according to a publicly known automatic trace design method. FIGS. 6-8 are diagrams showing a specific example of the determination of the trace route that passes through the final passing points determined as shown in FIG. 5 based on the automatic trace design method according to the first embodiment of the present invention. In this example, because the obstacles are existing traces other than the trace subject to route determination, the optimal route is found by using the invention as described in Japanese Unexamined Patent Publication No. 2007-079738. If the obstacles are anything other than the existing traces, the optimal route may be found, for example, by using the invention as described in Japanese Unexamined Patent Publication No. 2006-331017. Further, when optimal trace positions from respective pads to corresponding vias on a substrate are designed, if the traces tend to be oriented in directions substantially opposite to dominant directions in a portion, the optimal route may be found, for example, by using the invention as described in Japanese Unexamined Patent Publication No. 2006-268462.

In an automatic trace design method according to a second embodiment of the present invention, on a virtual plane corresponding to a substrate surface, with respect to a trace that is determined to terminate at any position on a predetermined line, optimal route positions are determined by using an arithmetic processing unit such as a computer. The predetermined line is a trace for connecting the trace subject to route determination in a T-junction manner, or an edge of a substrate from which the trace subject to route determination in the form of a plated lead is drawn out. In this automatic trace design method, an optimal trace route on the virtual plane corresponding to the substrate surface is constituted by connecting a plurality of segments.

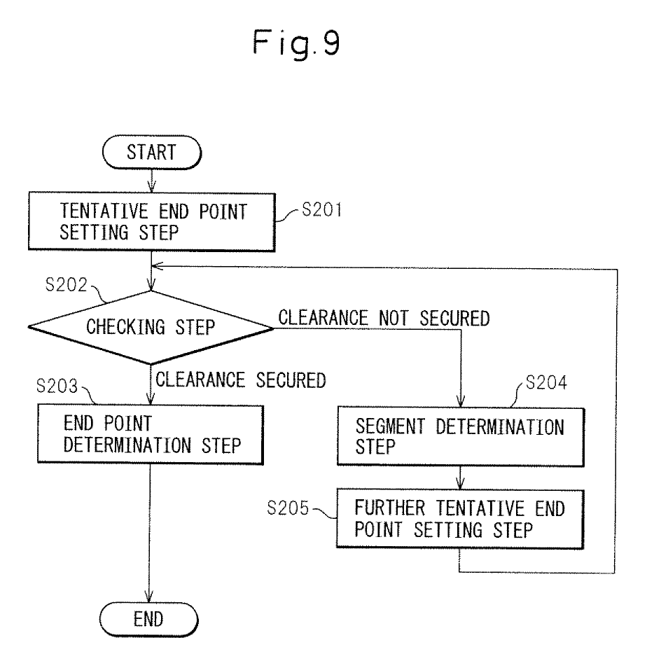

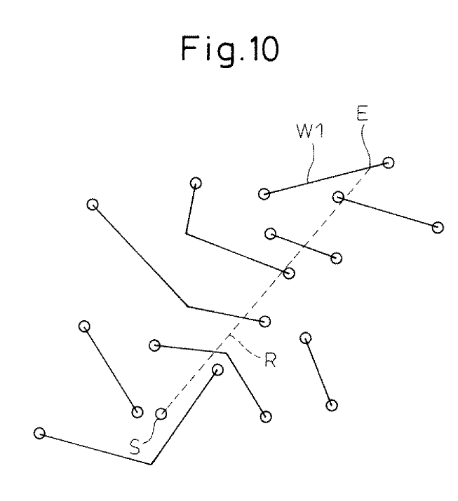

FIG. 9 is a flow chart showing an operational flow of the automatic trace design method according to the second embodiment of the present invention. Further, FIGS. 10-13 are diagrams showing a specific example of trace route determination based, on the second embodiment of the present invention. In FIGS. 10-13, trace terminals are indicated by circles and traces connecting between the terminals are indicated by solid lines.

As a specific example, as shown in FIG. 10, it is assumed that a position of a starting point S of a trace subject to route determination is already determined on the virtual plane and an end point E of the trace subject to route determination is only determined to be connected with any point on a trace W1 in a T-junction manner. In FIGS. 10-13, a connection relationship between the starting point S and the end point E is represented by a rat's nest R, which is indicated by a dotted line in the figures.

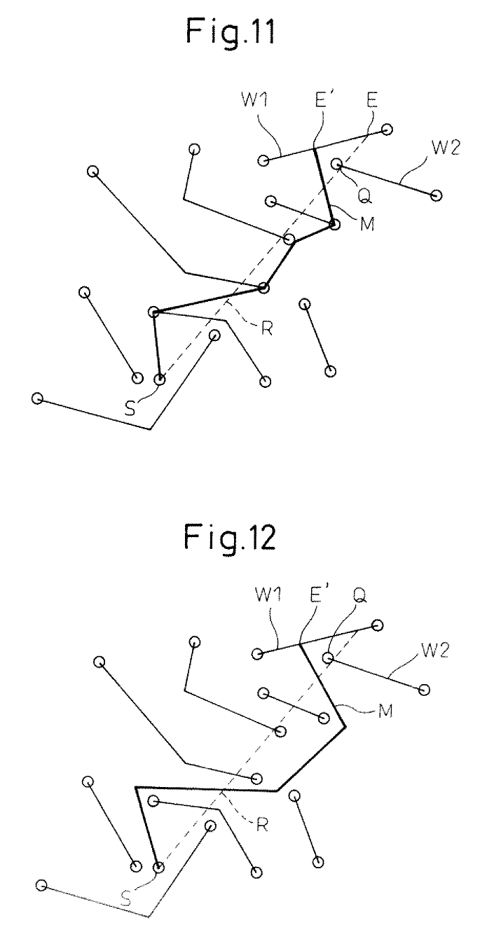

First, in a tentative end point setting step S201, on the virtual plane corresponding to the substrate surface, a tentative end point is set on said predetermined line where the trace subject to route determination should terminate. In this tentative end point setting step S201, the tentative end point is set so that a segment including the tentative end point or a terminating segment is orthogonal to the predetermined line. By applying the present invention to the example shown in FIG. 10, as shown in FIG. 11, a tentative end point E′ is set at a position where the terminating segment M is orthogonal to the trace W1.

Next, in a checking step S202, clearance from obstacles that are located in the neighborhood of the terminating segment and that may disturb trace design is checked. In the example shown in FIG. 11, the clearance from the terminal Q that is an obstacle located in the neighborhood of the terminating segment M is checked.

As a result of the check in the checking step S202, if it is determined that the clearance is secured, in an end point determination step S203, the position of the tentative end point at this time is determined as an end point of the trace subject to route determination. For example, in the case shown in FIG. 11, if the clearance between the terminating segment M and the terminal Q of the existing trace W2 located in the neighborhood of the terminating segment M is secured, the position of the tentative end point E′ at this time is determined as the end point of the trace subject to route determination. In this case, the route shown by a thick solid line in FIG. 11 is determined. Then, by correcting this route so as to secure clearance from other existing traces, an optimal route as shown in FIG. 12 can be obtained.

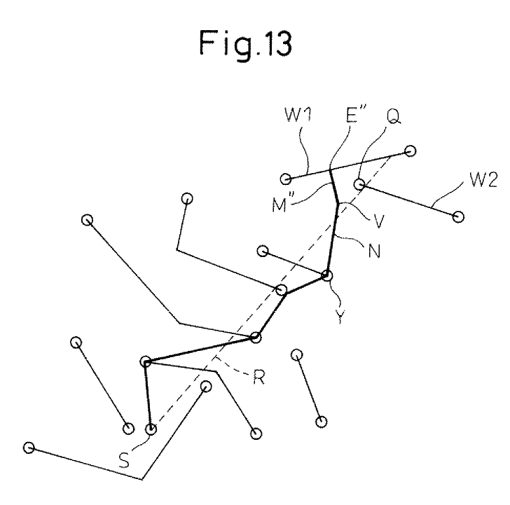

On the other hand, as a result of the check in the checking step S202, if it is determined that the clearance is not secured, in a segment determination step S204, a new segment that connects between a terminal point at the side opposite to the tentative end point of the terminating segment in question and a bend point from which the clearance can be secured is set as a portion of an optimal route of the trace subject to route determination. For example, in the case shown in FIG. 11, if the clearance between the terminating segment M and the terminal Q of the existing trace W2 located in the neighborhood of the terminating segment M is not secured, as shown in FIG. 13, a new segment N that connects between a terminal, point Y at the side opposite to the tentative end point E′ of the terminating segment M in the case of FIG. 11 and a bend point V from which the clearance can be secured is set as a portion of an optimal route of the trace subject to route determination.

Next, in a further tentative end point setting step S205, a new tentative end point is set on the predetermined line. In the further tentative end point setting step S205, the new end point is set so that a new terminating segment that connects between the new end point and the bend point in the segment determination step S204 is orthogonal to the predetermined line. After that, the process returns to the checking step S202. In the example shown in FIG. 13, a new tentative end point E″ is set on a trace W1. The new tentative end point E″ is set so that a new terminating segment M″ that connects the tentative end point E″ and the bend point V in the segment determination step S204 is orthogonal to the predetermined line. After that, the process returns to the checking step S202 where clearance check is performed with respect to the new terminating segment M″. For example, in the case shown in FIG. 13, if the clearance between the new terminating segment M″ and a terminal Q of an existing trace W2 located in the neighborhood of the new terminating segment M″ is secured, the position of the new tentative terminating point E″ is determined as the end point of the trace subject to route determination. In this case, the route shown by a thick solid line in FIG. 13 is determined. After that, by correcting this route so as to secure clearance from other existing traces, an optimal route can be obtained.

In an automatic trace design method according to a third embodiment of the present invention, on a virtual plane corresponding to a substrate surface, route positions of a plated lead on the substrate surface are determined by using the virtual plane corresponding to the substrate surface by an arithmetic processing unit.

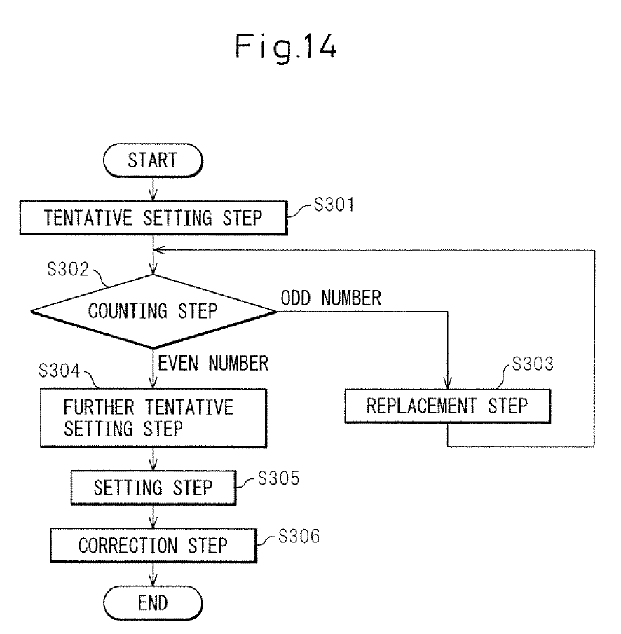

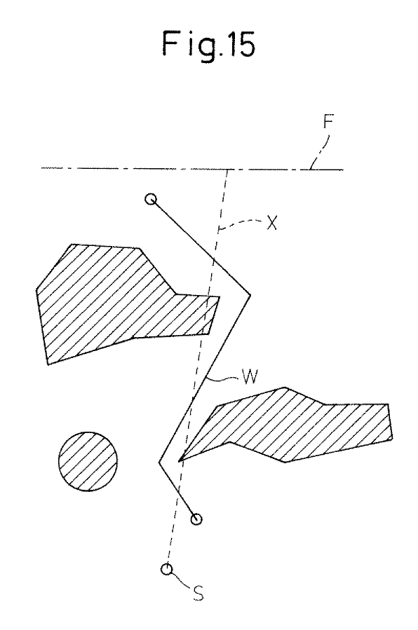

FIG. 14 is a flow chart showing an operational flow of the automatic trace design method according to the third embodiment of the present invention. Further, FIGS. 15-18 are diagrams showing a specific example of trace route determination based on the third embodiment of the present invention. In FIGS. 15-18, trace terminals are indicated by circles and an existing trace W connecting between the terminals is indicated by a solid line. Further, an edge F of the substrate is indicated by an alternate long and short dashed line. Still further, obstacles are indicated by oblique lines.

First, in a tentative setting step S301, on the virtual plane corresponding to the substrate surface, a tentative route (a tentative rat's nest) is set from a predetermined starting point of a plated lead to the edge of the substrate. In the example shown in FIG. 15, the starting point S of the plated lead is preliminarily determined as shown, and the tentative route X is set as shown by a dotted line in the figures.

Next, in a counting step S302, the number of intersections of the tentative route and an other existing trace is counted. In the example shown in FIG. 15, the tentative route and the other trace W intersect three times.

If the number of intersections counted in the counting step S302 is an odd number, in a replacement step S303, the tentative route is replaced by another tentative route that passes through terminals at both ends of the other existing trace and the process returns to the counting step S302.

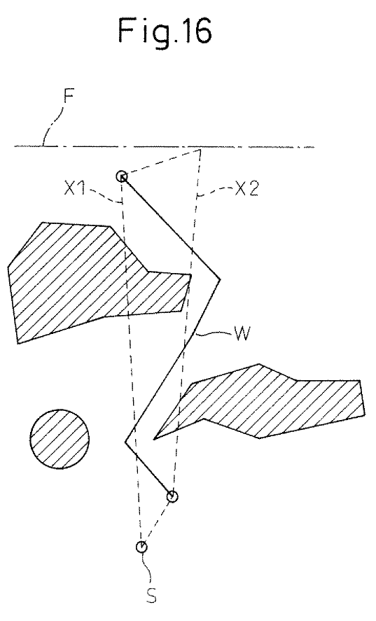

If the number of intersections counted in the counting step S302 is an even number, in a further tentative setting step S304, further tentative routes that connect between the starting point, the respective one of the bend points of the other trace, and an intersection point thereof with the edge of the substrate are set and, as a result, as shown in FIG. 16, the tentative route X of FIG. 15 is replaced by tentative routes X1 and X2.

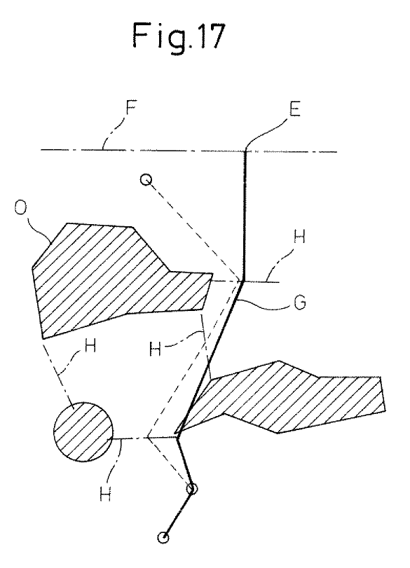

Next, in a setting step S305, one of the further tentative routes set in the further tentative setting step S304 that has a shorter distance between the starting point and the intersection point thereof with the edge of the substrate is set as a route to be corrected. In the example of FIG. 16, for example, the tentative route X2 is set as the route to be corrected G as shown in FIG. 17.

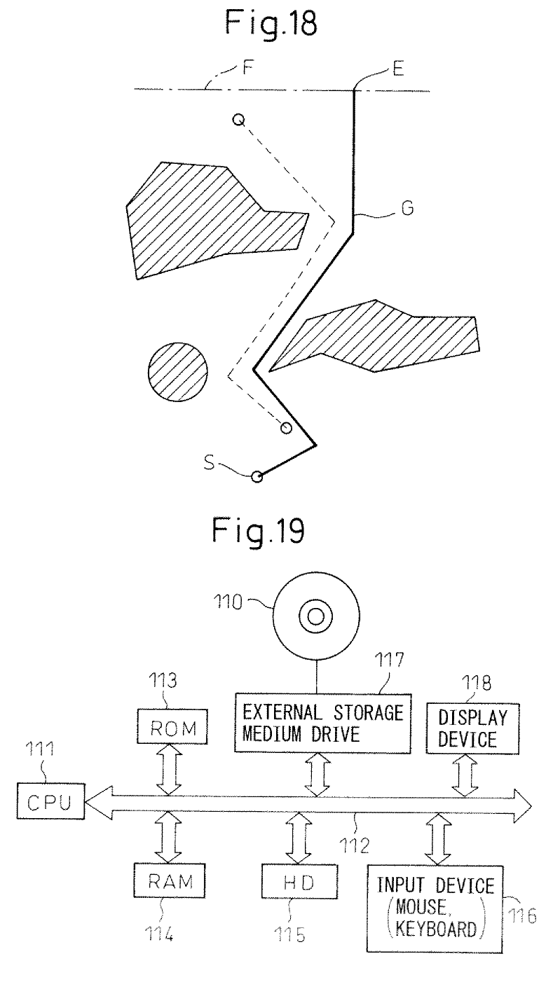

Then, in a correction step S306, the route to be corrected is corrected to an optimal route that can secure a predetermined clearance from obstacles that may disturb trace design. At this time, a route is set so as to run from a point on the optimal route in the neighborhood of the obstacle nearest to the edge of the substrate among the obstacles referenced in the route correction and so as to be orthogonal to the edge of the substrate. In the example shown in FIG. 17, an additional line H or a reference line for securing the predetermined clearance from the obstacles is drawn and, on the additional line H, the clearance between the route G to be corrected and the existing traces and/or the obstacles is checked. At this time, as shown in FIG. 17, a route is set so as to run from a point on the optimal route in the neighborhood of the obstacle O nearest to the edge F of the substrate among the obstacles referenced in the route correction and so as to be orthogonal to the edge F of the substrate. As a result, the optimal route of the plated lead is determined as shown by a thick solid line in FIG. 17. After that, by correcting this route so as to secure clearance from other existing traces, an optimal route as shown by a thick solid line in FIG. 18 can be obtained.

The automatic trace design method according to the embodiments described above is implemented by a computer. FIG. 19 is a block diagram showing a configuration of a computer that operates according to a program that is stored on a storage medium.

As shown in FIG. 19, a computer program for allowing a computer to perform the automatic trace design process according to the present invention is stored on a storage medium (an external storage medium such as a flexible disk, a CD-ROM, and the like) 110, and for example, it is installed in a computer configured as described below to operate as the automatic trace design apparatus.

A CPU 111 controls the automatic trace design apparatus entirely. This CPU 111 is connected with a ROM 113, a RAM 114, a HD (hard disk drive) 115, an input device 116 such as a mouse, a keyboard and the like, an external storage medium drive 117, and a display device 118 such as a LCD, a CRT, a plasma display, an organic EL and the like through a bus 112. A control program for the CPU 111 is stored in the ROM 113.

The program for performing the automatic trace design process according to the present invention (an automatic trace design process program) is installed (stored) from the storage medium 110 on the HD 115. Further, in the RAM 114, a working area for the CPU 111 to perform the automatic trace design process and an area for storing a portion, of the program for performing the automatic trace design process are secured. Moreover, in the HD 115, input data, final data and, further, an OS (operating system) and the like are stored in advance.

First, when the computer is turned on, the CPU 111 reads the control program from the ROM 110 and, further, reads the OS from the HD 115 to start the OS. As a result, the computer is ready to install the automatic trace design process program from the storage medium 110.

Next, the storage medium 110 is mounted on the external storage medium drive 117 and a control command is input from the input device 116 to the CPU 111 to read the automatic trace design process program, stored in the storage medium 110 and store it in the HD 115 and the like. Thus, the automatic trace design process program is installed on the computer.

After that, once the automatic trace design process program is activated, the computer operates as the automatic trace design apparatus. The operator can perform the automatic trace shaping process described above by manipulating the input device 116 according to working details and procedures through an interaction indicated on the display device 118. “Data about the optimal trace route” obtained as a result of the process may be, for example, stored on the HD 115 for utilization in the future, or may be used to indicate the results of the process on the display device 118 visually.

Although the computer program stored in the storage medium 110 is installed on the HD 115 in the computer of FIG. 19, the present invention is not limited to such implementation and the program may be installed on the computer through an information transmission medium such as a LAN and the like or the program may be installed in advance in the HD 115 built in the computer.

The present invention can be applied to an automatic trace design process by using an arithmetic processing unit not only in semiconductor integrated circuits such as LSI, PCB and the like, but also in semiconductor packages such as PBGA, EBGA and the like, or circuit boards such as MCM/SIP and the like.

According to the present invention, positions of a trace route on a substrate surface can be determined automatically in a short time by using a virtual plane corresponding to the substrate surface by an arithmetic processing unit. According to the present invention, not only in semiconductor integrated circuits such as LSI, PCB and the like, but also in semiconductor packages such as PBGA, EBGA and the like, or circuit boards such as MCM/SIP and the like, the trace route can be determined automatically by using the arithmetic processing unit. When the present invention is applied to trace design of circuit boards, desired trace routes can be designed readily in a short time without being influenced by the designer's skill, experience, intuition and the like as in the related art. For example, according to the present invention, the optimal trace routes, which took many days for the related-art manual trace design by trial and error, can be designed automatically within about a few hours or less. As a result of the reduction of design time and the burden on the designer, manufacturing costs of products can also be reduced. The optimal trace routes have shorter wiring lengths, and therefore, they can be more economical and they can be manufactured more easily and they have a lower rate of occurrence of product error in the manufacturing process. Further, the optimal trace routes are also electrically stable.

According to the first embodiment of the present invention, a trace design in which a designer's desire such as “a trace route is desired to pass through at least a particular area on a substrate surface” is reflected can be performed automatically in a short time by using an arithmetic processing unit.

According to the second embodiment of the present invention, even if a position of a terminal at an end point of a trace subject to route determination is uncertain in design data, such as when a position of a plated lead is determined or a trace subject to route determination is connected in a T-junction manner, the trace design can be performed automatically in a short time by using an arithmetic processing unit.

According to the third embodiment of the present invention, even by a so-called “automatic push” technique that is a conventionally used trace design technique for finding the trace route of a plated lead while shifting other traces, an appropriate position of the plated lead on an edge of a substrate can be found.

What is claimed is:

1. An automatic trace design method for determining positions of a trace route on a substrate surface by using a virtual plane corresponding to said substrate surface, wherein, on said virtual plane, with respect to a trace subject to route determination in which only positions of a starting point and an end point are determined, positions of an optimal route between said starting point and said end point are determined, the method comprising:
a tentative passing point setting step of setting, on said virtual plane, approximate positions through which said trace subject to route determination should at least pass as tentative passing points;
a triangle setting step of setting triangles, each of which is formed by one of said tentative passing points and two points on either side of such tentative passing point among said starting point, said end point and the other of said tentative passing points; and
a determination step of determining points in the neighborhood of respective obstacles that may disturb trace design and that are located inside said respective triangles and most adjacent to said respective tentative passing points as final passing points through which the trace subject to route determination should pass,
wherein the route that passes through said final passing points is determined as positions of the optimal route of said trace subject to route determination.

2. An automatic trace design method according to claim 1, further comprising a clearance securing step of correcting the positions of said final passing points so as to secure clearance between such final passing points and said obstacles.

3. An automatic trace design, method according to claim 1, wherein said obstacles are terminals of existing traces other than said trace subject to route determination.

4. An automatic trace design method for determining an optimal route of a trace on a substrate surface as a route that is constituted by connecting a plurality of segments on a virtual plane corresponding to said substrate surface by an arithmetic processing unit, wherein the optimal route is determined with respect to a trace subject to route determination that is determined to terminate at any position on a predetermined line on said virtual plane, the method comprising:
a tentative end point setting step of setting, on said virtual plane, a tentative end point on said predetermined line where said trace subject to route determination should terminate so that a segment including said tentative end point or a terminating segment is orthogonal to said predetermined line;
a checking step of checking clearance from obstacles that is located in the neighborhood of said terminating segment and that may disturb trace design; and
an end point determination step of determining the position of said tentative end point as an end point of said trace subject to route determination if the clearance is secured as a result of the check in said checking step.

5. An automatic trace design method according to claim 4, further comprising:
a segment determination step of setting a new segment that connects between a terminal point at the side opposite to said tentative end point of the terminating segment in question and a bend point from which the clearance can be secured as a portion of an optimal route of said trace subject to route determination if the clearance cannot be secured as a result of the check in said checking step; and
a further tentative end point setting step of setting a new tentative end point on said predetermined line so that a new terminating segment that connects between said new tentative end point and said bend point is orthogonal to said predetermined line,
wherein said checking step is further performed with respect to said new terminating segment.

6. An automatic trace design method according to claim 4, wherein said obstacles are terminals of existing traces other than said trace subject to route determination.

7. An automatic trace design method according to claim 4, wherein said predetermined line is a trace for connecting said trace subject to route determination in a T-junction manner.

8. An automatic trace design method according to claim 4, wherein said predetermined line is an edge of a substrate from which said trace subject to route determination in the form of a plated lead is drawn out.

9. An automatic trace design method for determining route positions of a plated lead on a substrate surface by using a virtual plane corresponding to said substrate surface by an arithmetic processing unit, the method comprising:
a tentative setting step of setting, on said virtual plane, a tentative route from a predetermined starting point of a plated lead to an edge of the substrate;
a counting step of counting the number of intersections of said tentative route and an other existing trace;
a replacement step of replacing said tentative route by another tentative route that passes through terminals at both ends of said other existing trace if said number of intersections is an odd number, wherein said counting process in said counting step is performed again for said new tentative route;
a further tentative setting step of setting further tentative routes that connect between said starting point, the respective one of the bend points of said other trace, and an intersection point of said tentative route and an edge of said substrate if said number of intersections is an even number;
a setting step of setting one of said further tentative routes that has a shorter distance between said starting point and said intersection point as a route to be corrected; and
a correction step for correcting said route to be corrected to an optimal route that can secure a predetermined clearance from obstacles that may disturb trace design, wherein a route is set so as to run from a point on said optimal route in the neighborhood of the obstacle nearest to the edge of said substrate among said obstacles referenced in the route correction and so as to be orthogonal to the edge of said substrate.
